(19) United States
(12) Patent Application Publication
(10) Pub. No.: US 2015/0147544 A1
(43) Pub. Date: May 28, 2015

(54) TEAR-RESISTANT PAPERBOARD LAMINATE

(71) Applicant: GERALD MINSKY, SHORT HILLS, NJ (US)

(72) Inventor: GERALD MINSKY, SHORT HILLS, NJ (US)

(21) Appl. No.: 14/088,679

(22) Filed: Nov. 25, 2013

(51) Int. Cl. B32B 27/10; B32B 27/36; B32B 37/18; B32B 27/40; B32B 7/12; B32B 37/12; B32B 27/32; B32B 27/34

(52) U.S. Cl. CPC B32B 27/10; B32B 27/32; B32B 27/36; B32B 27/34; B32B 27/40; B32B 7/12; B32B 37/12; B32B 37/18; B32B 2250/40; B32B 2305/08; B32B 2307/5825; B32B 2439/00
USPC 428/215; 428/537.5; 428/513; 428/481; 428/479.6; 428/425.1; 428/334; 428/339; 156/60; 156/334

(57) ABSTRACT

A paperboard laminate is described. The paperboard laminate includes a first paperboard layer. The first paperboard layer is printable on at least one side. A first side of a material that is tear-resistant in one direction is bonded to a first side of the first paperboard layer with an adhesive material. A second paperboard layer is bonded to a second side of the material with an adhesive material. The second paperboard layer is printable on at least one side.

### TECHNICAL FIELD

The present invention relates generally to a paperboard laminate that is resistant to tearing in one direction.

### BACKGROUND

A conventional tear-resistant packaging is made of a tear-resistant paperboard laminate including a paperboard layer which is bonded to a tear-resistant polymer film such as polyethylene, polyester, or the like. In some cases the paperboard is clay coated, on the exposed side, for printability. The resulting laminate generally includes a clay coated paperboard side and a film side. The film side of the laminate has a texture that is undesirable because it cannot accept conventional print.

### SUMMARY OF THE INVENTION

one aspect, the invention is embodied in a paperboard laminate. The paperboard laminate includes a first paperboard layer that is printable on at least one side. A material that is ear-resistant in one direction is bonded to a first side of the first paperboard layer. A second paperboard layer is bonded to a second side of the material. The second paperboard layer is printable on at least one side.

In one embodiment, the material has a tear resistance of at least 300 grams of force in the one direction as measured by the Elmendorf tear propagation test. The first and second paperboards can be bonded to the material with an adhesive material. Alternatively, the first and second paperboards are bonded to the material with a low-density polyethylene (LDPE) material. The material can be at least one of a plastic, Valeron™, polyester, polyamide and polyurethane film.

The material can have a thickness between about 1.0 and 5.0 mils. In one embodiment, at least one of the first and second paperboard layers can have a thickness between about 0.005 and 0.024 inches. In one embodiment, one side of each of the first and second paperboard layers is treated to support printing.

In another aspect, the invention is embodied in a method of manufacturing a paperboard laminate. The method includes providing a material that is tear-resistant in one direction. The material has a tear resistance in the one direction of at least 300 grams of force as measured by the Elmendorf tear propagation test. The method also includes bonding a first paperboard layer to a first side of the material with a first bonding agent. The method also includes bonding a second paperboard layer to a second side of the material with a second bonding agent.

In one embodiment, the method can also include treating one side of at least one of the first and second paperboard layers to support printing on the at least one side of the first and second paperboard layers. In one embodiment, the first and second bonding agents can include adhesive. The first and second bonding agents can include low-density polyethylene (LDPE) material.

The method can also include bonding the paperboard laminate to a second substantially similar paperboard laminate such that the one direction of the material in the paperboard laminate is substantially perpendicular to a direction of a tear-resistant material in the second substantially similar paperboard laminate to provide resistance to tearing in multiple directions.

In yet another embodiment, the invention is embodied in a tear-resistant paperboard laminate. The tear-resistant paperboard laminate includes a first paperboard laminate having a first paperboard layer and a first material that is tear-resistant in a first direction. A first side of the first material is bonded to a first side of the first paperboard layer. A second paperboard layer is bonded to a second side of the first material. The tear-resistant paperboard laminate includes a second paperboard laminate having a third paperboard layer. A second material is tear-resistant in a second direction. A first side of the second material is bonded to a first side of the third paperboard layer. A fourth paperboard layer is bonded to the second side of the second material. A bonding agent bonds the first paperboard laminate to the second paperboard laminate such that the first direction of the first material is substantially perpendicular to the second direction of the second material to provide resistance to tearing in multiple directions.

In one embodiment, the first material is substantially the same as the second material. The first paperboard laminate can be substantially the same as the second paperboard laminate. In one embodiment, the material has a tear resistance of at least 300 grams of force in the one direction as measured by the Elmendorf tear propagation test.

In one embodiment, the first and second paperboards are bonded to the material with an adhesive material. The first and second material can include at least one of plastic, Valeron™, polyester, polyamide or polyurethane film. In one embodiment, the first and second material comprises a thickness between about 1.0 and 5.0 mils.

### BRIEF DESCRIPTION OF THE FIGURES

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

The above and further advantages of this invention may be better understood by referring to the following description in conjunction with the accompanying drawings, in which like numerals indicate like structural elements and features in various figures. Skilled artisans will appreciate that reference designators shown herein indicate components shown in a figure other than the one in discussion. For example, talking about a device 10 while discussing Figure A would refer to an element, 10, shown in figure other than Figure A.

FIG. 1 illustrates a directional tear-resistant paperboard laminate according to one embodiment of the present invention;

FIG. 2 illustrates an exploded view of a tear-resistant package according to one embodiment of the present invention;

FIG. 3 illustrates a process for manufacturing a directional tear-resistant paperboard laminate according to one embodiment of the invention;

FIG. 4 illustrates another process for manufacturing a directional tear-resistant paperboard laminate according to one embodiment of the invention; and

FIG. 5 illustrates yet another process for manufacturing a directional tear-resistant paperboard laminate according to one embodiment of the invention.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description. For the purposes of conciseness, many conventional techniques and principles related to the manufacture of paperboard or paperboard laminates, need not, and are not, described in detail herein.

The following description may refer to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. The term “exemplary” is used in the sense of “example, instance, or illustration” rather than “model,” or “deserving imitation.”

Technologies and concepts discussed herein relate to paperboard laminates. According to one embodiment, the paperboard laminate includes a first paperboard layer that is printable on at least one side. A material having the property that it is tear-resistant in one direction is bonded to a first side of the first paperboard layer. A second paperboard layer is bonded to the second side of the material. The second paperboard layer is printable on at least one side.

In one embodiment, one paperboard laminate can be bonded to another paperboard laminate using a bonding agent that bonds the first paperboard laminate to the second paperboard laminate in such a way that a direction of the directional material in the one paperboard laminate is substantially perpendicular to a direction of the directional material in the other paperboard laminate to provide resistance to tearing in multiple directions.

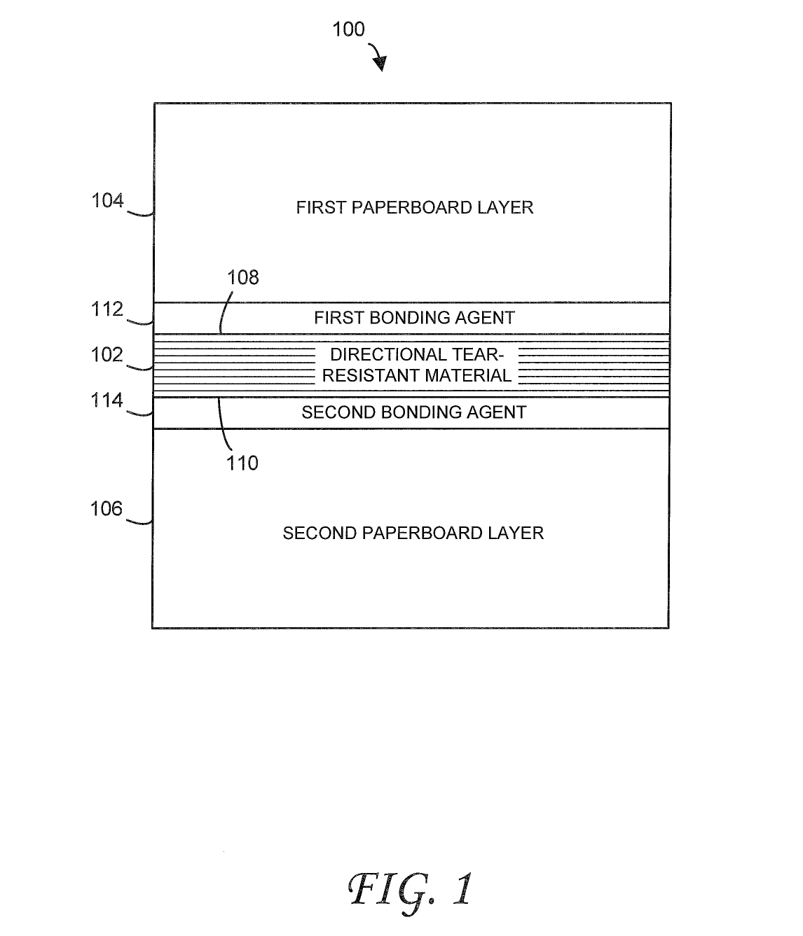

FIG. 1 illustrates a directional tear-resistant paperboard laminate 100 according to one embodiment of the present invention. The directional tear-resistant paperboard laminate 100 is a multilayer paperboard laminate having an integral directional tear-resistant material 102 that has a high resistance to tearing in one direction. In one embodiment, the directional tear-resistant material 102 is fabricated from plastic, Valeron™, polyester, polyamide or polyurethane film having a thickness of between about 1.0 and 5.0 mils. The directional tear-resistant material 102 has a high resistance to tearing in one direction, preferably a tear resistance of between about 300 and 3000 grams of force as measured by the Elmendorf tear propagation test.

In one embodiment, the directional tear-resistant paperboard laminate 100 includes a first paperboard layer 104, the integral directional tear-resistant material 102, and a second paperboard layer 106. The first and second paperboard layers 104, 106 can each include a coated side and an uncoated side. The integral directional tear-resistant material 102 can be bonded to the uncoated sides of the first and second paperboard layers 104, 106 to create the directional tear-resistant paperboard laminate 100.

In one specific embodiment, the directional tear-resistant paperboard laminate 100 includes the directional tear-resistant material 102 having first and second sides 108, 110. The laminate 100 also includes the first paperboard layer 104 bonded to the first side 108 of the directional tear-resistant material 102, with a first bonding agent 112. The laminate 100 further includes the second paperboard layer 106 bonded to the second side 110 of the directional tear-resistant material 102, with a second bonding agent 114. The first and second bonding agents 112, 114 can be the same or can be different bonding agents.

In one embodiment, the directional tear-resistant material 102 can have a thickness of between about 1.0 mil to 5.0 mil. The directional tear-resistant material 102 can have a tear resistance in one direction of between about 300 grams of force and 3000 grams of force (depending on the thickness and other properties of the material 102) as measured by the Elmendorf tear propagation test.

In one embodiment, at least one of the first paperboard layer 104 and the second paperboard layer 106 is coated with clay on one side thereof, to facilitate printing on the surface of the first paperboard layer 104 and/or the second paperboard layer 106. The first and/or second bonding agents 112, 114 can include an adhesive material, such as a liquid adhesive. In one embodiment, the first and/or second bonding agents 112, 114 can include an extrusion-applied molten low-density polyethylene (LDPE) material. The first and/or second paperboard layers 104, 106 can have a thickness of between 0.005 inches and 0.024 inches.

As previously described, the directional tear-resistant material 102 can be fabricated from at least one of plastic, Valeron™, polyester, polyamide or polyurethane films. The directional tear-resistant material 102 can have a thickness ranging from about 1.0 mils to 5.0 mils. As previously described, in one embodiment, the 1.0 mil tear-resistant material has a tear resistance of approximately 300 grams of force in the one direction as measured by the Elmendorf tear propagation test. In another embodiment, a 3.0 mil tear-resistant material has a tear resistance of approximately 1700 grams of force in the one direction as measured by the Elmendorf tear propagation test. A 5.0 mil tear-resistant material has a tear resistance of approximately 3000 grams of force in the one direction as measured by the Elmendorf tear propagation test.

Thus, the directional tear-resistant paperboard laminate 100 includes five layers. The first layer is the paperboard layer 104. The second layer is the bonding agent 112 including an adhesive, such as a liquid adhesive or a LDPE that is bonded to the paperboard layer 104 and the directional tear-resistant material 102. In practice, any suitable liquid adhesive can be used, such as ethylene vinyl acetate, polyurethane, acrylic or acrylate polymer, for example.

The third layer is the directional tear-resistant material 102 that is resistant to tearing in one direction. The directional tear-resistant paperboard laminate 100 tear strength can be controlled by varying the type of material and the film weight of the directional tear-resistant material 102. In general, an increase in film thickness results in an increase in tear-resistance. In one embodiment, a tear-resistant material 102 having a thickness of 3.0 mil has a tear resistance of approximately 1700 grams of force as measured by the Elmendorf tear propagation test.

The fourth layer is the bonding agent 114 including an adhesive, such as a liquid adhesive or a LDPE that is bonded to the directional tear-resistant material 102 and the second paperboard layer 106. The fifth layer is the paperboard layer 106. In one embodiment, each of the paperboard layers 104, 106 can include a coated side and an uncoated side. The coated side can be coated with clay to facilitate printing on the coated side.

In one embodiment, the first and second paperboard layers 104, 106 are substantially structurally identical, in that they have substantially the same mechanical properties. For example, the first paperboard layer 104 mirrors the second paperboard layer 106 in relation to the directional tear-resistant material 102. The resulting directional tear-resistant paperboard laminate 100 is thus structurally symmetrical.

Skilled artisans will appreciate that minor manufacturing differences between the first and second paperboard layers 104, 106 can exist without departing from the scope of the invention. For example, in one embodiment, only one paperboard layer 104 can be clay coated while the other paperboard layer 106 is uncoated. Preferably, the first and second paperboard layers 104, 106 are fabricated from the same material and have approximately the same thickness. However, in other embodiments, the paperboard layers 104, 106 can be fabricated from different materials and/or can have varying thickness.

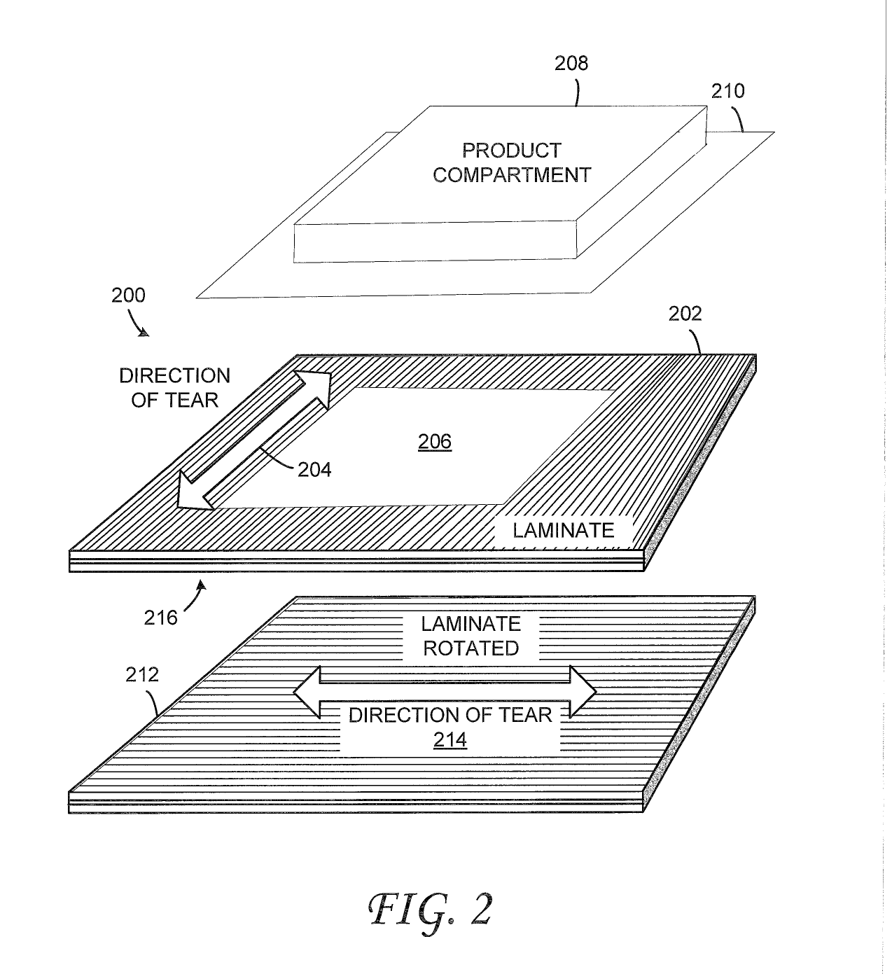

FIG. 2 illustrates an exploded view of a tear-resistant package 200 according to one embodiment of the present invention. The tear-resistant package 200 includes a first paperboard laminate 202 having a directional tear-resistant material that is resistant to tearing in one direction 204. The first paperboard laminate 202 can include an opening 206 that is configured to accommodate a compartment 208 for containing an item such as a product. The opening 206 can be any suitable shape and/or size. In one embodiment, the first paperboard laminate 202 can include a plurality of openings to accommodate a plurality of compartments (not shown).

In one embodiment, the compartment 208 can be fabricated from a substantially transparent material, such as plastic to enable the contents inside the compartment 208 to be viewable. In another embodiment, the compartment 208 can be fabricated from an opaque material, whereby any items contained within the compartment 208 are substantially hidden from view when the package 200 is assembled. In practice, any suitable material can be used. The compartment 208 can include a rim 210 that extends outward from the compartment 208. The rim 210 prevents the compartment 208 from passing through the opening 206 when the package 200 is assembled.

The package 200 also includes a second paperboard laminate 212 having a directional tear-resistant material that is resistant to tearing in one direction 214. The second paperboard laminate 212 is rotated by approximately ninety degrees relative to the first paperboard laminate 202 such that the one direction 204 of the material in the first paperboard laminate 202 is substantially perpendicular to a direction 214 of the tear resistant material in the second paperboard laminate 212 to provide resistance to tearing in multiple directions.

In one embodiment, the compartment 208 is sized and shaped to fit tightly in the opening 206 to prevent tampering of objects in the compartment 208 when the package 200 is assembled. For example, the rim 210 of the compartment 208 can be secured between the first and second paperboard laminate 202, 212 during packaging assembly. For example, in order to secure the compartment 208, the rim 210 extends around the open end of the compartment 208 such that when the compartment 208 is inserted through the opening 206, the rim 210 can be bonded to the underside 216 of the first paperboard laminate 202 to prevent the compartment 208 from being pulled through the opening 206. While a contiguous rim 210 is shown in the FIG. 2, it should be appreciated that the compartment 208 can be retained in the package 200 by a non-contiguous rim, a series of tabs or other suitable techniques.

In one embodiment, the package 200 is assembled as follows. The compartment 208 is inserted into the opening 206. An item or label can be placed within the compartment 208. The first and the second paperboard laminates 202, 212 are than bonded together using an adhesive, such as a heat-sealed adhesive. In practice, any suitable adhesive or attaching technique can be used to assemble the package 200.

The package 200 can also include a small opening (not shown) at one end of the package 200 or elsewhere that is sized to enable the package 200 to be placed onto a rack or product display board (not shown) at the point of sale, for sale, or for display.

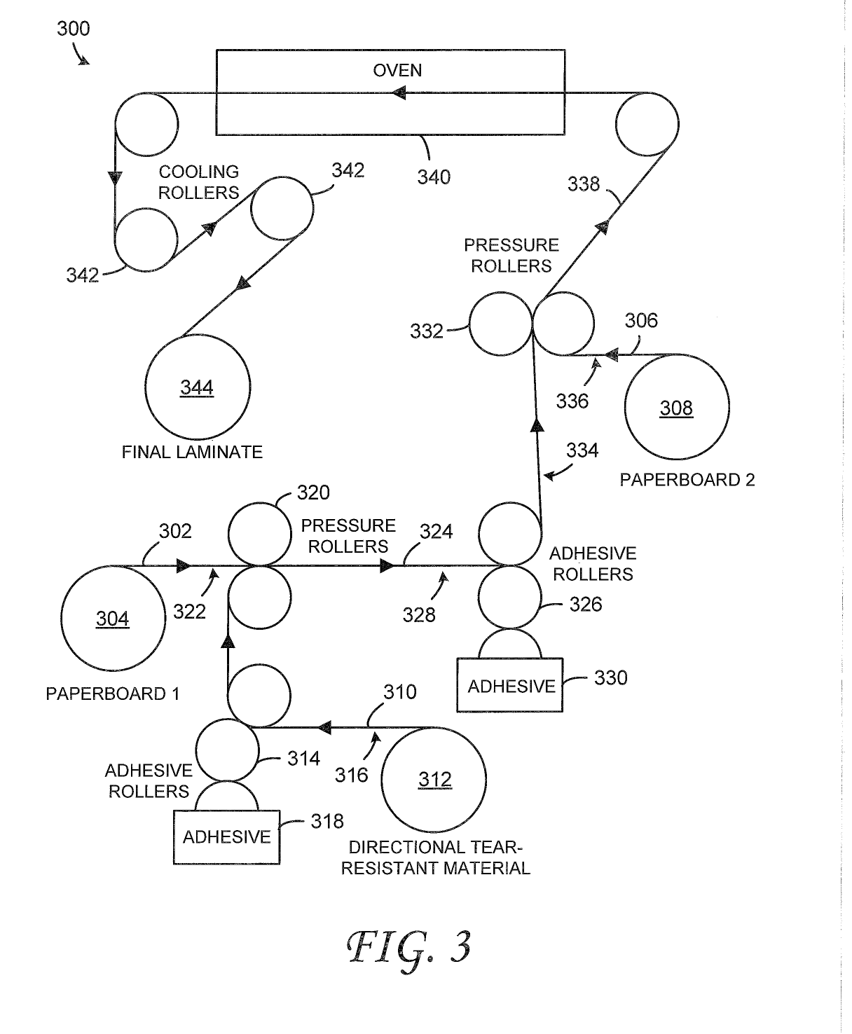

FIG. 3 illustrates a process 300 for manufacturing a directional tear-resistant paperboard laminate according to one embodiment of the invention. A first paperboard 302 is initially loaded on a first roll 304. A second paperboard 306 is initially loaded on a second roll 308. A directional tear-resistant material 310 is initially loaded on a third roll 312.

The directional tear-resistant material 310 unwinds from the third roll 312 toward adhesive rollers 314. A first side 316 of the directional tear-resistant material 310 is coated with an adhesive 318 via the adhesive rollers 314. The directional tear-resistant material 310 with the adhesive coating then travels to pressure rollers 320 and meets the first paperboard 302 which is being unwound from the first roll 304. The adhesive coated first side 316 of the directional tear-resistant material 310 contacts a second side 322 of the first paperboard 302 and they both enter the pressure rollers 320 to be bonded together. It should be noted that metering, coating, and pressure load specifics are known to skilled artisans and for clarity are not detailed herein.

The first paperboard-material laminate 324 exiting the pressure rollers 320 then travels to adhesive rollers 326. A second side 328 of the directional tear-resistant material 310 is coated with an adhesive 330 via the adhesive rollers 326. The first paperboard-material laminate 324 with the adhesive coating then travels to pressure rollers 332 and meets the second paperboard 306 which is being unwound from the second roll 308. The adhesive coated second side 334 of the directional tear-resistant material 310 contacts a first side 336 of the second paperboard 306 and they both enter the pressure rollers 332 to be bonded together.

The first paperboard-material-second paperboard laminate 338 existing from the pressure rolls 332 then travels to an oven 340 where the adhesive of the laminate is cured and set. The first paperboard-material-second paperboard laminate 338 exits the oven 340 and travels through cooling rollers 342 for cooling before being wound on a final rewind roll 344.

Skilled artisans will appreciate that other techniques can be used to manufacture the laminate according to the invention. For example, in one embodiment, the adhesive(s) 318, 330 can be replaced by using a low-density polyethylene (LDPE) (not shown). This manufacturing technique requires processing of the directional tear-resistant material 310 using, for example, a corona treatment chamber.

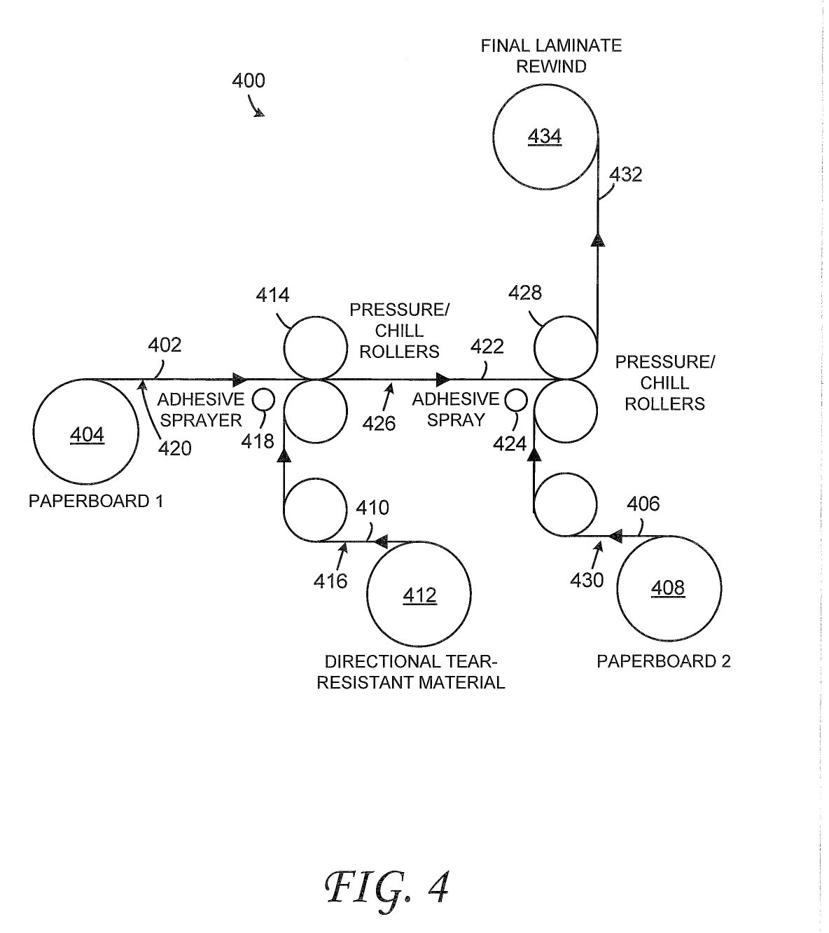

FIG. 4 illustrates another process 400 for manufacturing a directional tear-resistant paperboard laminate according to one embodiment of the invention. A first paperboard 402 is initially loaded on a first roll 404. A second paperboard 406 is initially loaded on a second roll 408. A directional tear-resistant material 410 is initially loaded on a third roll 412.

The directional tear-resistant material 410 unwinds from the third roll 412 towards pressure/chill rollers 414. A first side 416 of the directional tear-resistant material 410 is coated with an adhesive sprayed from an adhesive sprayer 418. The directional tear-resistant material 410 with the adhesive coating then travels to the pressure/chill rollers 414 and meets the first paperboard 402 which is being unwound from the first roll 404. The adhesive coated first side 416 of the directional tear-resistant material 410 contacts a second side 420 of the first paperboard 402 and they both enter the pressure\chill rollers 414 to be bonded together. It should be noted that metering, coating, and pressure load specifics are known to skilled artisans and for clarity are not detailed herein.

The first paperboard-material laminate 422 exiting the pressure\chill rollers 414 then travels toward adhesive sprayer 424. A second side 426 of the directional tear-resistant material 410 is coated with an adhesive sprayed from the adhesive sprayer 424. The first paperboard-material laminate 422 with the adhesive coating then travels to pressure\chill rollers 428 and meets the second paperboard 406 which is being unwound from the second roll 408.

The adhesive coated second side 426 of the directional tear-resistant material 410 contacts a first side 430 of the second paperboard 406 and they both enter the pressure\chill rollers 428 to be bonded together. The first paperboard-material-second paperboard laminate 432 existing from the pressure\chill rollers 428 is then wound on a final rewind roll 434.

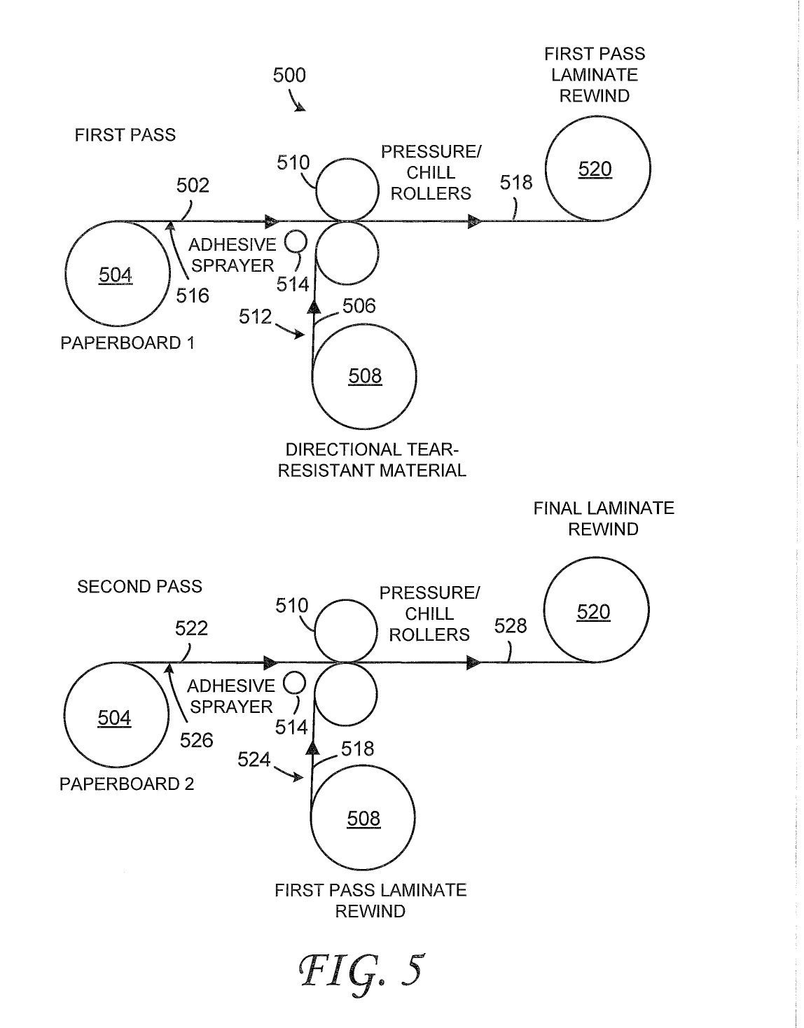

FIG. 5 illustrates yet another process 500 for manufacturing a directional tear-resistant paperboard laminate according to one embodiment of the invention. Skilled artisans will appreciate that the process 500 is a two-pass process in which the laminate is fabricated by passing the partially-complete laminate through the manufacturing equipment twice. A first paperboard 502 is initially loaded on a first roll 504. A directional tear-resistant material 506 is initially loaded on a second roll 508.

The directional tear-resistant material 506 unwinds from the second roll 508 towards pressure/chill rollers 510. A first side 512 of the directional tear-resistant material 506 is coated with an adhesive sprayed from the adhesive sprayer 514. The directional tear-resistant material 506 with the adhesive coating then travels to pressure/chill rollers 510 and meets the first paperboard 502 which is being unwound from the first roll 504. The adhesive coated first side 512 of the directional tear-resistant material 506 contacts a second side 516 of the first paperboard 502 and they both enter the pressure\chill rollers 510 to be bonded together. The first paperboard-material laminate 518 exiting the pressure\chill rollers 510 is then wound on a rewind roll 520. It should be noted that metering, coating, and pressure load specifics are known to skilled artisans and for clarity are not detailed herein.

The first paperboard-material laminate 518 is then removed from the rewind roll 520 and loaded onto the second roll 508. A second paperboard 522 is loaded onto the first roll 504. The first paperboard-material laminate 518 unwinds from the second roll 508 towards pressure/chill rollers 510. A second side 524 of the first paperboard-material laminate 518 is coated with an adhesive sprayed from the adhesive sprayer 514.

The second paperboard 522 then travels to the pressure\chill rollers 510 and meets first paperboard-material laminate 518 with the adhesive coating which is being unwound from the second roll 508. The adhesive coated second side 524 of the first paperboard-material laminate 518 contacts a first side 526 of the second paperboard 522 and they both enter the pressure\chill rollers 510 to be bonded together. The first paperboard-material-second paperboard laminate 528 existing from the pressure\chill rollers 510 is then wound on the rewind roll 520.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A paperboard laminate comprising:
a first paperboard layer, the first paperboard layer being printable on at least one side;
a material that is tear-resistant in one direction, a first side of the material being bonded to a first side of the first paperboard layer; and
a second paperboard layer bonded to a second side of the material, the second paperboard layer being printable on at least one side.

2. The paperboard laminate of claim 1, wherein the material has a tear resistance of at least 300 grams of force in the one direction as measured by the Elmendorf tear propagation test.

3. The paperboard laminate of claim 1, wherein the first and second paperboards are bonded to the material with an adhesive material.

4. The paperboard laminate of claim 1, wherein the first and second paperboards are bonded to the material with a low-density polyethylene (LDPE) material.

5. The paperboard laminate of claim 1, wherein the material comprises at least one of plastic, Valeron™, polyester, polyamide and polyurethane film.

6. The paperboard laminate of claim 1, wherein the material comprises a thickness between about 1.0 and 5.0 mils.

7. The paperboard laminate of claim 1, wherein at least one of the first and second paperboard layers comprises a thickness between about 0.005 and 0.024 inches.

8. The paperboard laminate of claim 1, wherein one side of each of the first and second paperboard layers is treated to support printing.

9. A method of manufacturing a paperboard laminate, the method comprising:
providing a material that is tear-resistant in one direction, the material having a tear resistance in the one direction of at least 300 grams of force as measured by the Elmendorf tear propagation test;
bonding a first paperboard layer to a first side of the material with a first bonding agent; and
bonding a second paperboard layer to a second side of the material with a second bonding agent.

10. The method according to claim 9, further comprising treating one side of at least one of the first and second paperboard layers to support printing on the at least one side of the first and second paperboard layers.

11. The method according to claim 9, further comprising bonding the paperboard laminate to a second substantially similar paperboard laminate such that the one direction of the material in the paperboard laminate is substantially perpendicular to a direction of a tear-resistant material in the second substantially similar paperboard laminate to provide resistance to tearing in multiple directions.

12. The method according to claim 9, wherein at least one of the first and second bonding agents comprises adhesive.

13. The method according to claim 9, wherein at least one of the first and second bonding agents comprises a low-density polyethylene (LDPE) material.

14. A tear-resistant paperboard laminate comprising:
a first paperboard laminate comprising:
a first paperboard layer;
a first material that is tear-resistant in a first direction, a first side of the first material being bonded to a first side of the first paperboard layer; and
a second paperboard layer bonded to a second side of the first material;
a second paperboard laminate comprising:
a third paperboard layer;
a second material that is tear-resistant in a second direction, a first side of the second material being bonded to a first side of the third paperboard layer; and
a fourth paperboard layer bonded to the second side of the second material; and
a bonding agent that bonds the first paperboard laminate to the second paperboard laminate such that the first direction of the first material is substantially perpendicular to the second direction of the second material to provide resistance to tearing in multiple directions.

15. The tear-resistant paperboard laminate of claim 14, wherein the first material is substantially the same as the second material.

16. The tear-resistant paperboard laminate of claim 14, wherein the first paperboard laminate is substantially the same as the second paperboard laminate.

17. The tear-resistant paperboard laminate of claim 14, wherein the material has a tear resistance of at least 300 grams of force in the one direction as measured by the Elmendorf tear propagation test.

18. The tear-resistant paperboard laminate of claim 14, wherein the first and second paperboards are bonded to the material with an adhesive material.

19. The tear-resistant paperboard laminate of claim 14, wherein the first and second material comprise at least one of plastic, Valeron™, polyester, polyamide and polyurethane film.

20. The tear-resistant paperboard laminate of claim 14, wherein at least one of the first and second material comprises a thickness between about 1.0 and 5.0 mils.
